(19) United States
(12) Patent Application Publication
(10) Pub. No.: US 2026/0188947 A1
(43) Pub. Date: Jul. 2, 2026

(54) SELF-LOCKING POWER PLUG

(71) Applicant: YFC-BONEAGLE ELECTRIC CO., LTD., Taoyuan City (TW)

(72) Inventors: Sheng-Cheng SHEN, Taoyuan City (TW); Qing CHEN, Wuxi (CN); Huiyu JI, Wuxi (CN)

(21) Appl. No.: 19/037,096

(22) Filed: Jan. 25, 2025

(30) Foreign Application Priority Data
Dec. 27, 2024 (TW) 113214340

(51) Int. Cl. H01R 13/629

(52) U.S. Cl. CPC H01R 13/629

(57) ABSTRACT

A self-locking power plug includes: an insulation base having an engage surface and defining an insertion direction, a rail and a first channel, a second channel and a third channel are disposed in the insulation base; plural conductive members mounted in the insulation base and exposed in the aforesaid three channels; a locking sheet disposed in the insulation base and having a penetrated hole, a fixed side and a moveable side; a slide block disposed on the rail and sliding between a locked position and a released position, the slide block hooks the moveable side to drive the locking sheet to rotate; and an elastic unit disposed in the insulation base and abutting against the insulation base and the slide block to make the slide block be preloaded with a force along a direction opposite to the insertion direction and towards the locked position.

### BACKGROUND OF THE DISCLOSURE

### Technical Field

The present disclosure relates to a power connecting device, especially to a self-locking power plug having advantages of being stably inserted and easily removed.

### Description of Related Art

A power plug is a power connecting device applied in a related-art electronic device. After the power plug is inserted into a power socket, conductive copper sheets in the power socket are used to clamp the power plug to prevent the power plug from being removed. Because the conductive copper sheets have a limited clamping force, the power plug is easily removed from the power socket when a power cable is accidentally pulled by an external force, thus the power supplying status is terminated. Moreover, the power plug is used to transfer the high-voltage current, the situation of the power plug being accidentally removed may cause electrical shock, thus how to stably insert the power plug into the power socket and not easily to be removed due to the external force shall be improved.

Accordingly, the applicant of the present disclosure has devoted himself for improving the mentioned shortages.

### SUMMARY OF THE INVENTION

The present disclosure provides a self-locking power plug having advantages of being stably inserted and easily removed.

Accordingly, the present disclosure provides a self-locking power plug, inserted into a power socket. The power socket includes a socket body and a plurality of conductive insertion pins. The socket body has an engage slot, and the conductive insertion pins are convexly disposed in the engage slot. The self-locking power plug includes an insulation base, a plurality of conductive members, a locking sheet, a slide block and an elastic unit. The insulation base has an engage surface and defines an insertion direction facing the engage surface. A rail and a first channel, a second channel and a third channel communicating with the engage surface are disposed in the insulation base in a direction parallel to the insertion direction, and the first channel is disposed between the second channel and the third channel. The conductive members are mounted in the insulation base and respectively exposed in the first channel, the second channel and the third channel. The locking sheet is disposed in the insulation base and transversally crosses the first channel. The locking sheet has a penetrated hole, a fixed side and a moveable side opposite to the fixed side. The fixed side is positioned in the insulation base and disposed at one side of the first channel closer to the third channel. The moveable side is moveably disposed at one side of the first channel closer to the second channel. The slide block is disposed on the rail and slides along the rail between a locked position and a released position. The slide block hooks the moveable side of the locking sheet to drive the locking sheet to rotate. The slide block has a handgrip extended to be out of the insulation base. The elastic unit is disposed in the insulation base and abuts against the insulation base and the slide block to make the slide block be preloaded with a force along a direction opposite to the insertion direction and towards the locked position. When the insulation base is inserted in the engage slot, the conductive insertion pins are respectively inserted in the first channel, the second channel and the third channel to be connected to each of the conductive members; wherein when the slide block is at the released position, the locking sheet is arranged to be perpendicular to a longitudinal direction of the first channel to make the conductive insertion pin longitudinally move in the first channel; wherein when the slide block is at the locked position, the moveable side of the locking sheet is driven by the slide block to make the locking sheet rotate, the penetrated hole is inclined relative to the longitudinal reflective rotations of the first channel till an inner edge of the penetrated hole being latched at a location defined at a lateral edge of the conductive insertion pin in the first channel.

When the self-locking power plug is inserted into the power socket, the conductive insertion pin corresponding to the first channel abuts against the moveable side of the locking sheet to make the locking sheet rotate, meanwhile the slide block slides from the locked position to the released position to make the self-locking power plug be further inserted into the power socket. When the self-locking power plug is no longer inserted in the engage slot, the conductive insertion pin stops pushing the locking sheet, the elastic unit pushes the slide block towards the locked position. The locking sheet rotates and the rotations stop when the inner edge of the penetrated hole is latched at the location defined at the lateral edge of the conductive insertion pin in the first channel. Accordingly, the locking sheet locks the corresponding conductive insertion pin, and the self-locking power plug is unable to be removed from the power socket.

When the self-locking power plug is desired to be removed from the power socket, a user holds the handgrip to pull the self-locking power plug to make the slide block be moved towards the released position, the slide block drives the locking sheet to rotate to make the penetrated hole of the locking sheet be perpendicular to the longitudinal direction of the first channel, thus the conductive insertion pin in the first channel is longitudinally moved, and the self-locking power plug is continuously pulled to be removed from the power socket.

### BRIEF DESCRIPTION OF THE DRAWINGS

FIG. 1 is a perspective exploded view showing the self-locking power plug according to one embodiment of the present disclosure;

FIG. 2 is another perspective exploded view showing the self-locking power plug according to one embodiment of the present disclosure;

FIG. 3 is a perspective view showing the self-locking power plug according to one embodiment of the present disclosure;

FIG. 4 is another perspective view showing the self-locking power plug according to one embodiment of the present disclosure;

FIG. 5 is a schematic view showing the slide block of the power connecting device being at the locked position according to one embodiment of the present disclosure;

FIG. 6 and FIG. 7 are schematic views showing the inserting actions of the power connecting device according to one embodiment of the present disclosure; and

FIG. 8 is a schematic view showing the slide block of the power connecting device being at the released position according to one embodiment of the present disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

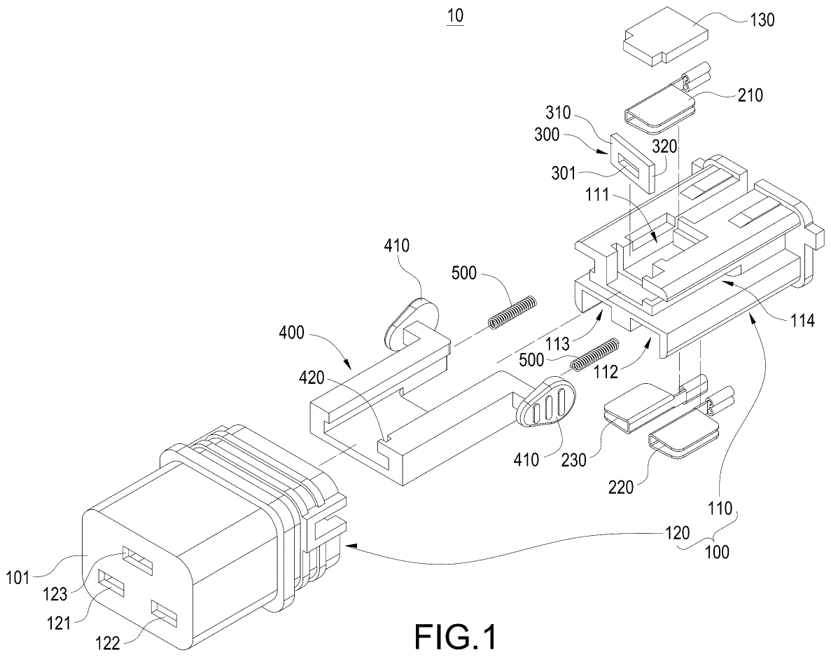

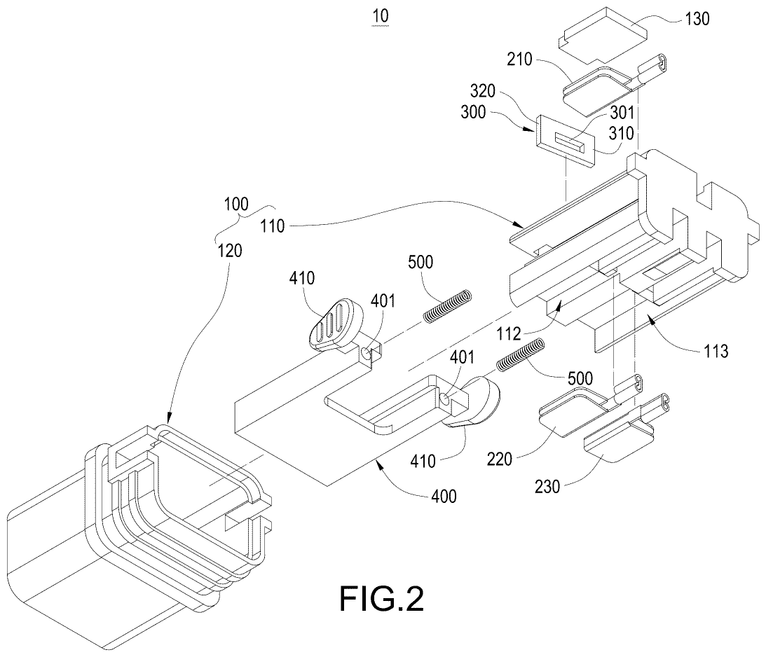

FIG. 1 is a perspective exploded view showing a self-locking power plug 10 according to one embodiment of the present disclosure; and FIG. 2 is another perspective exploded view showing the self-locking power plug 10 according to one embodiment of the present disclosure. Please refer to FIG. 1 and FIG. 2, the present disclosure provides a self-locking power plug 10, which includes an insulation base 100, a plurality of conductive members 210, 220, 2300, a locking sheet 300, a slide block 400 and an elastic unit 500.

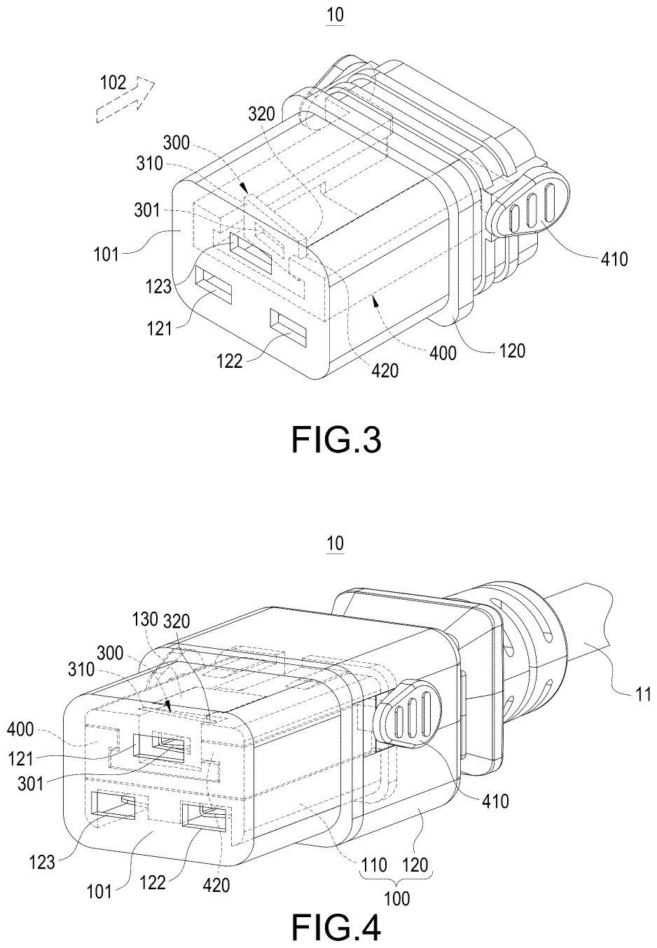

FIG. 3 is a perspective view showing the self-locking power plug 10 according to one embodiment of the present disclosure. Please refer to FIG. 3, the insulation base 100 has an engage surface 101. The insulation base 100 defines an insertion direction 102. Substantially speaking, the insertion direction 102 is defined as a direction vertically towards the engage surface 101.

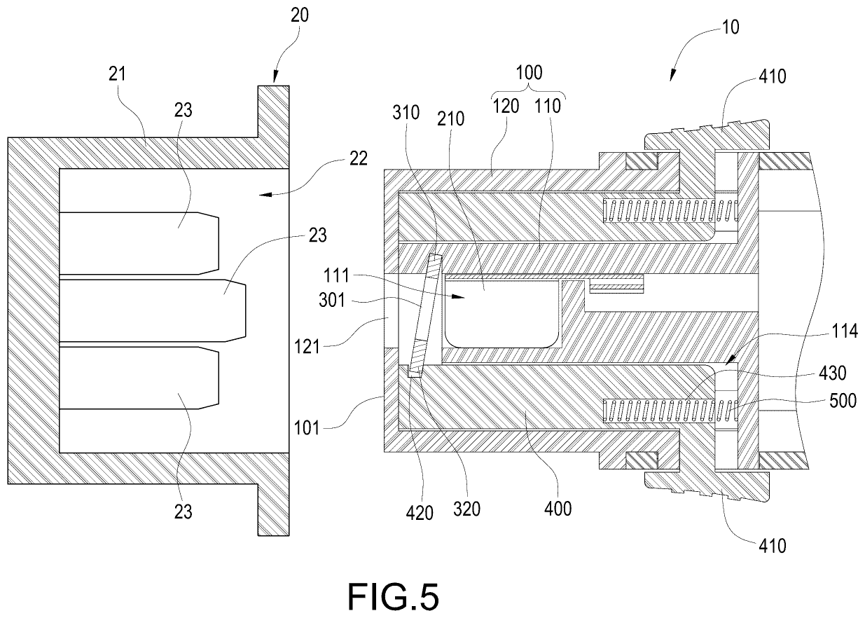

FIG. 4 is another perspective view showing the self-locking power plug 10 according to one embodiment of the present disclosure. Please refer from FIG. 1 to FIG. 4, a rail 114, a first channel 111, a second channel 112 and a third channel 113 are disposed in the insulation base 100. The first channel 111, the second channel 112 and the third channel 113 communicate with the engage surface 101. Substantially speaking, the insulation base 100 includes a main body 110 and a housing 120. The main body 110 is disposed in the housing 120. The first channel 111, the second channel 112 and the third channel 113 are disposed in the main body 110. The engage surface 101 is formed on the housing 120. The engage surface 101 has a plurality of insertion holes 121, 122, 123 longitudinally aligned with the first channel 111, the second channel 112 and the third channel 113, thus the first channel 111, the second channel 112 and the third channel 113 respectively communicate with the engage surface 101. The first channel 111 is disposed at one side of the main body 110. The first channel 111 is parallelly arranged relative to the insertion direction 102. The second channel 112 and the third channel 113 are disposed at another side of the main body 110 opposite to the first channel 111. The first channel 111, the second channel 112 and the third channel 113 all have one opened side. The rail 114 is disposed at one another side defined between the two aforesaid sides of the main body 110. Relative positions of cross sections of the first channel 111, the second channel 112 and the third channel 113 defined on the insulation base 100 are arranged in a triangular manner (referring relative positions of the insertion holes 121, 122, 123 arranged on the engage surface 101). The first channel 111 is arranged between the second channel 112 and the third channel 113.

The conductive members 210, 220, 230 are mounted in the insulation base 100. The conductive members 210, 220, 230 are respectively disposed in the first channel 111, the second channel 112 and the third channel 113, thus the conductive members (210, 220, 230) are exposed in the first channel 111, the second channel 112 and the third channel 113. In some embodiments, the conductive members 210, 220, 230 respectively pass the opened sides of the first channel 111, the second channel 112 and the third channel 113 to be disposed in the first channel 111, the second channel 112 and the third channel 113. The insulation base 100 further includes a press block 130. The press block 130 is disposed in the main body 110 and used to press and fasten the conductive member 210 in the first channel 111. The conductive members 220, 230 in the second channel 112 and the third channel 113 are pressed and fastened by the housing 120. Please refer to FIG. 4, the conductive members 210, 220, 230 are further connected to a cable 11.

Please refer from FIG. 1 to FIG. 3, the locking sheet 300 is disposed in the insulation base 100. The locking sheet 300 is arranged between one end of the first channel 111 and the insertion hole 121 corresponding to the first channel 111, thus the locking sheet 300 vertically crosses a longitudinal direction of the first channel 111. The locking sheet 300 has a penetrated hole 301, a fixed side 310 and a moveable side 320 opposite to the fixed side 310. The fixed side 310 of the locking sheet 300 is positioned in the insulation base 100. The moveable side 320 of the locking sheet 300 is moveably arranged. The fixed side 310 and the moveable side 320 are respectively disposed at two sides of the first channel 111. The moveable side 320 is arranged to be close to the second channel 112, and the fixed side 310 is arranged to be close to the third channel 113. The moveable side 320 of the locking sheet 300 is longitudinally aligned with the rail 114.

Please refer from FIG. 2 to FIG. 4, the slide block 400 is disposed on the rail 114. The slide block 400 is limited to be in the rail 114 via the housing 120, thus the slide block 400 slides along the rail 114. Substantially speaking, the structure of the slide block 400 is defined corresponding to the rail 114 on which the slide block 400 is disposed. The slide block 400 has a handgrip 410. The handgrip 410 is extended to be out of the insulation base 100 to make a user push the slide block 400. The slide block 400 has a hook 420. The hook 420 hooks the moveable side 320 of the locking sheet 300 to drive the locking sheet 300 to rotate. One side of the slide block 400 away from the engage surface 101 is convexly formed with a longitudinal hole 430. The longitudinal hole 430 is longitudinally extended along the rail 114.

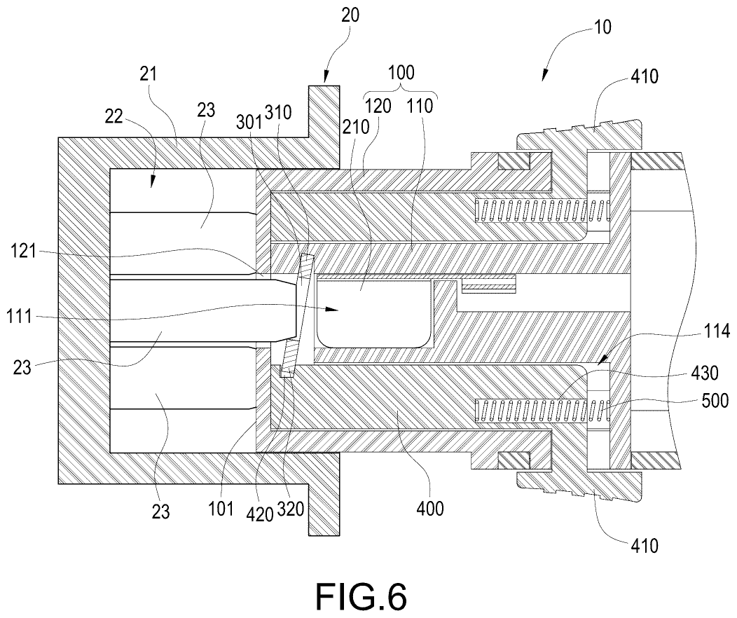

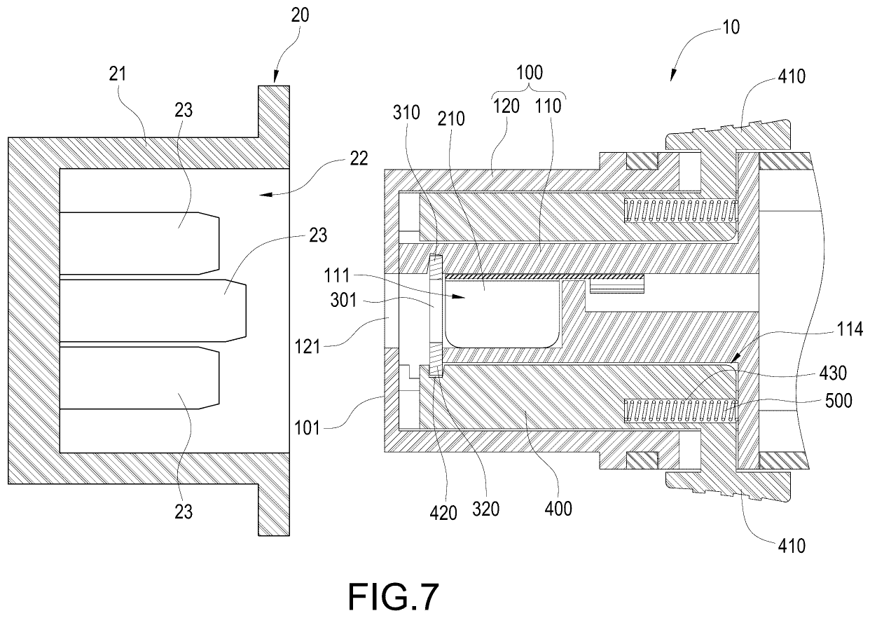

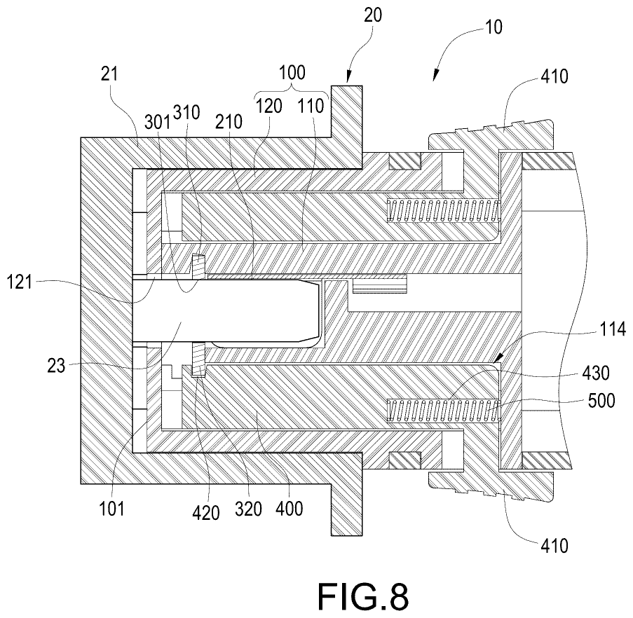

FIG. 5 is a schematic view showing the slide block 400 of the power connecting device being at the locked position according to one embodiment of the present disclosure; FIG. 6 and FIG. 7 are schematic views showing the inserting actions of the power connecting device according to one embodiment of the present disclosure; and FIG. 8 is a schematic view showing the slide block 400 of the power connecting device being at the released position according to one embodiment of the present disclosure.

The slide block 400 slides along the rail 114 between a locked position adjacent to the engage surface 101 as shown in FIG. 5 and a released position away from the engage surface 101 as shown in FIG. 8. Please refer from FIG. 1 to FIG. 4, the elastic unit 500 is disposed in the insulation base 100 and abuts against the insulation base 100 and the slide block 400 to make the slide block 400 be preloaded with a force along a direction opposite to the insertion direction 102 and towards the locked position. Please refer to FIG. 5, the elastic unit 500 is disposed in the rail 114. The elastic unit 500 is inserted in the longitudinal hole 430 to be fastened. As such, the elastic unit 500 is supported through an inner wall at one end of the rail 114 away from the engage surface 101 to make the elastic unit 500 push the slide block 400 to the locked position. As shown in FIG. 5, when the slide block 400 is at the locked position, the locking sheet 300 is arranged to be longitudinally inclined relative to the first channel 111. As shown in FIG. 8, when the slide block 400 is at the released position, the locking sheet 300 is arranged to be perpendicular to the longitudinal direction of the first channel 111.

Please refer to FIG. 5, the present disclosure provides a power connecting device including the aforesaid self-locking power plug 10 and a power socket 20. The power socket 20 includes a socket body 21 and a plurality of conductive insertion pins 23 corresponding to each of the conductive members 210, 220, 230. The socket body 21 has an engage slot 22. The conductive insertion pins 23 are convexly disposed in the engage slot 22.

Please refer to FIG. 6 and FIG. 7, the engage slot 22 is used to make the insulation base 100 be inserted therein. The conductive insertion pins 23 respectively pass each of the insertion holes 121, 122, 123 to be inserted in the first channel 111, the second channel 112 and the third channel 113, and connected to each of the conductive members 210, 220, 230.

Please refer to FIG. 6, when the insulation base 100 is inserted in the engage slot 22, the conductive insertion pin 23 corresponding to the first channel 111 abuts against the moveable side 320 of the locking sheet 300 to make the locking sheet 300 rotate till being perpendicular to the longitudinal direction of the first channel 111, meanwhile the slide block 400 slides from the locked position to the released position. At this moment, the conductive insertion pin 23 passes the penetrated hole 301 of the locking sheet 300 to be inserted in the first channel 111 to make the insulation base 100 be further inserted in the engage slot 22, and the other conductive insertion pins 23 are respectively inserted in the corresponding second channel 112 and the corresponding third channel 113.

Please refer to FIG. 7, when the insulation base 100 is no longer inserted in the engage slot 22, the conductive insertion pin 23 stops pushing the locking sheet 300, the elastic unit 500 pushes the slide block 400 towards the locked position. When the slide block 400 moves to the locked position, the moveable side 320 of the locking sheet 300 is driven by the slide block 400 to make the locking sheet 300 rotate, the penetrated hole 301 is inclined relative to the longitudinal reflective rotations of the first channel 111 to make the projection area of the longitudinal cross section of the penetrated hole 301 defined on the first channel 111 be gradually decreased. The locking sheet 300 rotates and the rotations stop when an inner edge of the penetrated hole 301 is latched at a location defined at a lateral edge of the conductive insertion pin 23 in the first channel 111. Accordingly, the locking sheet 300 locks the corresponding conductive insertion pin 23, thus the self-locking power plug 10 is unable to be removed from the power socket 20.

Please refer to FIG. 8, when the self-locking power plug 10 is desired to be removed from the power socket 20, the user holds the handgrip 410 to pull the self-locking power plug 10 to make the slide block 400 be moved towards the released position, the slide block 400 drives the locking sheet 300 to rotate to make the penetrated hole 301 of the locking sheet 300 be perpendicular to the longitudinal direction of the first channel 111, thus the conductive insertion pin 23 in the first channel 111 is longitudinally moved, and the self-locking power plug 10 is continuously pulled to be removed from the power socket 20.

While this disclosure has been described by means of specific embodiments, numerous modifications and variations may be made thereto by those skilled in the art without departing from the scope and spirit of this disclosure set forth in the claims.

What is claimed is:

1. A self-locking power plug, inserted to a power socket, the power socket comprising a socket body and a plurality of conductive insertion pins, the socket body comprising an engage slot, the conductive insertion pins convexly disposed in the engage slot, the self-locking power plug comprising:
an insulation base, comprising an engage surface, an insertion direction defined towards the engage surface, a rail disposed therein parallel to the insertion direction, and a first channel, a second channel and a third channel communicating with the engage surface disposed therein parallel to the insertion direction, wherein the first channel is disposed between the second channel and the third channel;
a plurality of conductive members, mounted in the insulation base and respectively exposed from the first channel, the second channel and the third channel;
a locking sheet, disposed in the insulation base and transversally crossing a longitudinal direction of the first channel, and comprising a penetrated hole, a fixed side and a moveable side opposite to the fixed side, wherein the fixed side is positioned in the insulation base, the moveable side is moveably disposed, the fixed side and the moveable side are respectively disposed at two sides of the first channel, the moveable side is arranged to be close to the second channel, and the fixed side is arranged to be close to the third channel;
a slide block, disposed on the rail and slidable along the rail between a locked position and a released position, wherein the slide block hooks the moveable side of the locking sheet to drive the locking sheet to rotate, the slide block comprises a handgrip extended to be out of the insulation base; and
an elastic unit, disposed in the insulation base and abutting against the insulation base and the slide block to make the slide block be preloaded with a force along a direction opposite to the insertion direction and towards the locked position;
wherein, when the slide block is at the released position, the locking sheet is arranged to be perpendicular to the longitudinal direction of the first channel to make one of the conductive insertion pins longitudinally move in the first channel;
wherein, when the slide block is at the locked position, the locking sheet is in an inclined status relative to the longitudinal direction of the first channel;
wherein, when the insulation base is inserted in the engage slot, the conductive insertion pins are respectively inserted in the first channel, the second channel and the third channel to be connected to each of the conductive members, the slide block moves towards the locked position to drive the moveable side of the locking sheet to make the locking sheet rotate, the penetrated hole is inclined relative to longitudinal rotation of the first channel till an inner edge of the penetrated hole being latched at a location defined at a lateral edge of the conductive insertion pin in the first channel.

2. The self-locking power plug according to claim 1, wherein the insulation base comprises a main body and a housing, the main body is disposed in the housing, the first channel, the second channel and the third channel are disposed in the main body, the engage surface is disposed on the housing, and the engage surface comprises a plurality of insertion holes longitudinally aligned with the first channel, the second channel and the third channel.

3. The self-locking power plug according to claim 2, wherein the locking sheet is arranged between one end of the first channel and the insertion hole corresponding to the first channel, and the moveable side of the locking sheet is longitudinally aligned with the rail.

4. The self-locking power plug according to claim 2, wherein the slide block is limited in the rail via the housing.

5. The self-locking power plug according to claim 2, wherein the rail is disposed at one side of the main body, and the first channel, the second channel and the third channel are disposed at another side of the main body opposite to the rail.

6. The self-locking power plug according to claim 5, wherein the first channel, the second channel and the third channel are opened at one side, and the conductive members are respectively disposed in the first channel, the second channel and the third channel.

7. The self-locking power plug according to claim 6, wherein the insulation base comprises a press block, and the press block is disposed in the main body to press and fasten the conductive member in the first channel.

8. The self-locking power plug according to claim 1, wherein the elastic unit respectively abuts against the slide block and one end of the rail away from the engage surface.

9. The self-locking power plug according to claim 8, wherein the slide block comprises a longitudinal hole, and the elastic unit is inserted in the longitudinal hole.

10. The self-locking power plug according to claim 1, wherein the slide block comprises a hook, and the hook hooks the moveable side of the locking sheet.
